(19) United States
(12) Patent Application Publication
(10) Pub. No.: US 2003/0029889 A1
(43) Pub. Date: Feb. 13, 2003

(54) Package for dispensing a cosmetic composition

(75) Inventors: Guy Richard Thompson, Inverness, IL (US); Thomas F. Wiegner, St. Charles, IL (US)

Correspondence Address: UNILEVER, PATENT DEPARTMENT, 45 RIVER ROAD, EDGEWATER, NJ, 07020, US

(73) Assignee: Unilever Home & Personal Care USA, Division of CONOPCO, INC.

(21) Appl. No.: 09/928,950

(22) Filed: Aug. 13, 2001

(51) Int. Cl. B67D 5/42; G01F 11/00

(52) U.S. Cl. 222/386.5; 222/389

(57) ABSTRACT

A package based upon an air pump system is provided for dispensing a cosmetic composition. In one aspect, the package provides enhanced delivery of the composition without affecting the stability of the composition. The pump system includes a bulb system and a balloon element in fluid communication therewith. Compression of the bulb system transmits air from the bulb system into the balloon to inflate the balloon, applying pressure to the composition to extrude it through an exit orifice in the container. When the bulb system is decompressed, some air returns from the balloon to the bulb system, thereby releasing pressure on the composition.

### FIELD OF THE INVENTION

The present invention relates to improved packages for dispensing cosmetic compositions, and more particularly, to a package for dispensing an antiperspirant or deodorant composition using an air pump system.

### BACKGROUND OF THE INVENTION

Cosmetic compositions, such as for example dental, skin, hair, and antiperspirant and deodorant formulations, can comprise a number of forms, such as a liquid or cream, or possibly a gel or micronized powder. Such compositions are dispensed in a variety of packages that are commercially available or otherwise known in the respective art.

The antiperspirant and deodorant product group is designed to provide effective perspiration and odor control while also being cosmetically acceptable during and after application onto the underarm area or other areas of the skin. Antiperspirant creams have become increasingly more popular as an effective alternative to antiperspirant sprays and solid sticks. These creams can be applied by conventional means, or packaged into topical dispensers to make topical application more efficient and less messy. Many of these creams, however, are cosmetically unacceptable to a large number of antiperspirant users because application can be messy and extrusion from the container difficult. Moreover, the creams can be pressure sensitive so that application of a force to extrude the cream composition out of its container can cause pressure build-up within the container and thus affect the stability of the composition.

Antiperspirant deodorant compositions are disclosed in U.S. Pat. No. 5,534,245 and International Patent Application WO 98/51185. International Patent Application WO 00/64302 discloses a package suitable for dispensing a flowable cosmetic composition. Use of pumps in connection with support devices is disclosed in U.S. Pat. Nos. 5,113,599; 5,437,615; and 5,987,779.

An object of the present invention to provide a package for dispensing a cosmetic composition, preferably a flowable antiperspirant composition, which provides enhanced delivery of the composition without affecting the stability of the composition.

Another object of the present invention is to provide a packaging system for easy extrusion of a cosmetic composition from the package.

Other objects of the present invention will become apparent to those skilled in the art by reference to the specification.

As used herein, the term “comprising” means including, made up of, composed of, consisting and/or consisting essentially of. Except in the operating and comparative examples, or where otherwise explicitly indicated, all numbers in this description indicating amounts or ratios of material or conditions of reaction, physical properties of materials and/or use are to be understood as modified by the word “about”.

### SUMMARY OF THE INVENTION

A package based upon an air pump system is provided for dispensing a cosmetic composition, particularly an antiperspirant or deodorant composition. In one aspect, the package provides enhanced delivery of the composition without affecting the stability of the composition. The pump system includes a bulb system and a balloon element in fluid communication therewith, whereby compression of the bulb system transmits air from the bulb system into the balloon to inflate the balloon, applying pressure to the composition to extrude it through an exit orifice in the container. When the bulb system is decompressed, some air returns from the balloon to the bulb system, thereby releasing pressure on the composition.

In one embodiment, the package includes:

a container containing a cosmetic composition and having opposing first and second ends, the first end having at least one exit orifice; and

a pump system for extruding the composition through the exit orifice located on the container in a position other than the first end, the pump system including:

(b1) a bulb secured to the container and extending from it at a location other than the first end, the bulb having an opening therein;

(b2) an internal member secured to the container and extending into the container;

(b3) the bulb and the internal member being affixed to define an enclosed volume therein;

(b4) a valve, preferably a one-way valve, located within the internal member and extending into the container.

The pump system optionally includes a balloon element disposed within the container and adjacent the internal member. The valve extends from the internal member into the balloon element. Compression of the bulb transmits air through the valve and into the balloon element to inflate the balloon element, thereby applying pressure to the composition in the container to thereby extrude the composition through the exit orifice. In one aspect, the bulb may be made of a material with good memory, allowing it to return to a pre-depressed state.

In another preferred embodiment, pressure relief is provided after inflation, with a package for dispensing deodorant or antiperspirant compositions for topical application to human skin including:

a container containing a cosmetic composition and having opposing first and second ends, the first end having an exit orifice or a plurality of exit orifices, the container having an opening in a position other than the first end;

a pump system for extruding the composition through the exit orifice, the pump system located on the container in said position other than the first end, the pump system including:

(b1) a bulb system secured to the container and extending from it at said position other than the first end about the opening therein, the bulb system including a first bulb having a perimeter edge and extending over the opening and a second bulb having a perimeter edge and and extending beyond and encompassing the first bulb, wherein the respective perimeter edges of the first bulb and the second bulb are concentrically adjacent, wherein the second bulb has an opening therein;

(b2) preferably a one-way valve, located at said position other than the first end, preferably, between the respective perimeter edges of the first bulb and the second bulb;

(b3) a balloon element disposed within the container, extending at least so as to enclose the valve and the opening in the container, to the first balloon.

Compression of the second bulb compresses the first bulb, transmitting air through the valve into the balloon, inflating the balloon and extruding the composition through the exit orifices. Once the pressure on the bulbs is released, a volume of air returns from the balloon into the first bulb to provide pressure relief on the composition. The degree of pressure relief can be controlled by adjusting the ratio of the volume of the first bulb to the volume of the second bulb.

In another aspect, the first and second bulbs are adjacent, with the first bulb extending about the opening in the container, and the second bulb extending about the valve.

A cap seatable over said first end of said container is further provided. Optionally, a support member extending from the container and housing the bulb system may be provided.

### BRIEF DESCRIPTION OF THE DRAWINGS

The following figures are intended for purposes of illustration and example.

FIG. 1 is a perspective view of an embodiment of the present invention;

FIG. 2 is a side elevational view of the embodiment according to FIG. 1;

FIG. 3 is a bottom view of the embodiment according to FIG. 1;

FIG. 4A is a partial cross-sectional view taken along line 4A-4A of FIG. 3 with the bulb in a static position;

FIG. 4B is a partial cross-sectional view similar to that of FIG. 4A but showing the bulb in an activated position;

FIG. 4C is a partial cross-sectional view similar to FIG. 4B showing a second step of the activation, with the balloon element fully inflated;

FIG. 4D is a partial cross-sectional view similar to FIG. 4C showing a third step of the bulb being re-inflated; and

FIGS. 5A-D are diagrammatical representations of a second preferred embodiment of the pump system of the present invention during operation; and

FIGS. 6A-D are diagrammatical representations of a variant of the embodiment of FIGS. 5A-D.

### DETAILED DESCRIPTION OF THE INVENTION

The present invention relates to a package for dispensing a cosmetic composition, such as a dental, skin, hair, antiperspirant or deodorant composition. Preferably, for flowable compositions such as a flowable antiperspirant or deodorant composition, which may experience synerisis upon being subjected to pressure, the present invention provides enhanced delivery of the composition without affecting the stability of the composition. Flowable compositions are meant to encompass soft solid or cream cosmetic formulations having a hardness of at least about 0.003 N/mm² at 25° C. Hardness, especially of soft solids, can be measured by a conventional sphere indentation technique, using a Stable Micro systems TA.XT2I™ Texture Analyzer. In some antiperspirant and deodorant formulations in the form of soft solids herein, the so measured hardness is up to about 0.05 N/mm² at 25° C. and particularly up to about 0.02 N/mm² at 25° C.

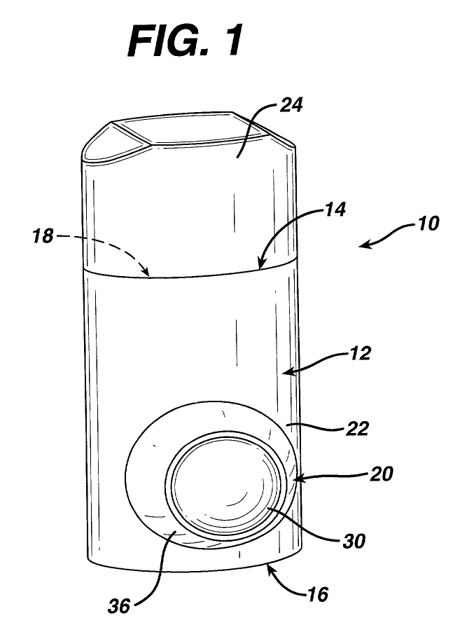

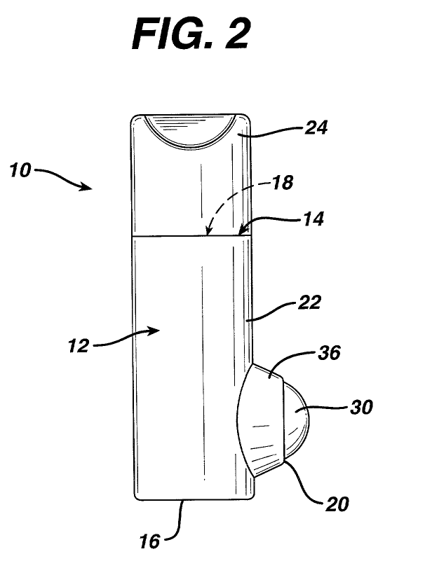

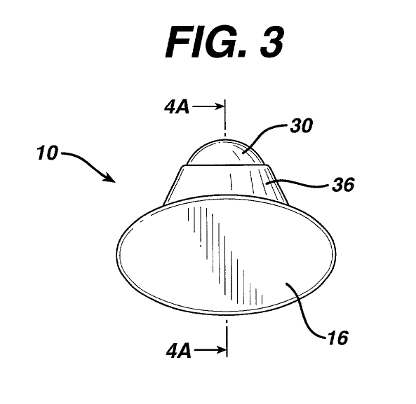

Referring to the accompanying drawings, FIGS. 1-3 provide perspective, elevational, and bottom views of a preferred embodiment of the package of the present invention. In the preferred embodiment, package 10 includes a container 12 with opposing first and second ends, 14 and 16, respectively, side wall 22, and a cap 24 seated on container 12. In the preferred embodiment, container 12 is constructed from thermoplastic materials. Polyolefins such as polyethylene and, preferably, polypropylene, are most suitable plastic materials. Other suitable material known to persons of ordinary skill in the art is contemplated to be within the scope of the present invention.

First end 14 has exit orifice 18. In other embodiments, first end 14 may contain a plurality of exit orifices, depending on the design desired for container 12. In the preferred embodiment, a pump system 20 is located on side wall 22 of container 12. It should be noted that pump system 20 may be located at any location on container 12 other than first end 14. The flexibility of pump system 20 allows for any shape container 12. Cap 24 is seatable over first end 14 to enclose exit orifice 18 when package 10 is not in use.

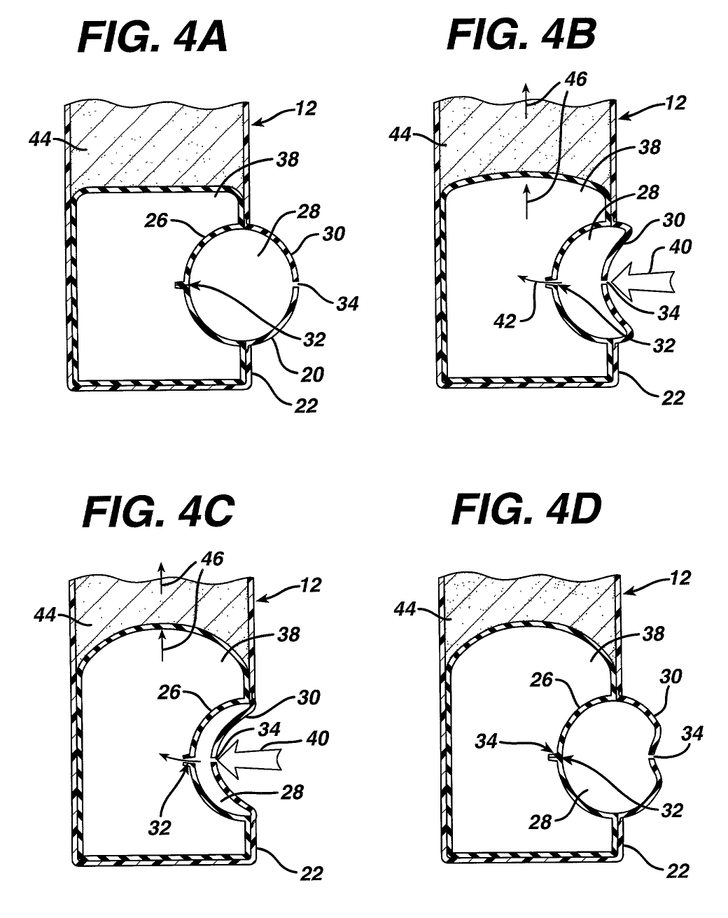

In a first preferred embodiment of the present invention, with reference to FIGS. 4A-D, pump system 20 comprises an internal member 26 disposed in and extending into container 12 and bulb 30 extending outwardly from container 12 beyond side wall 22. Bulb 30 is affixed to internal member 26 and secured to container 12 by means commonly known to persons of ordinary skill in the art such as through a heat seal, ultrasonic welding, or a clip seal. Bulb 30 and support 26 define enclosed volume 28 therebetween. Bulb 30 may be constructed from materials such as rubber or other elastomeric material. Internal member 26 may be constructed from either a rigid moldable material or from elastomeric material, depending on the desired effect for pump system 20. Bulb 30 and internal member 26 may optionally be disposed within support member 36, which extends from container 12 and defines an opening to surround and house bulb 30. Support 36 is constructed from any rigid moldable material such as thermoplastic polymers.

As a variation, bulb 30 may be integrally formed, such as by bi-injection molding, with side wall 22, where side wall 22 could be molded from a polyolefin thermoplastic and the area encompassing bulb 30 could be molded from an elastomeric or rubber material.

Internal member 26 has a valve 32 disposed therein and extending from within enclosed volume 28 into container 12. Valve 32 is preferably a one-way valve so that air may pass through valve 32 in the direction 42 from bulb 30 but cannot return through valve 32 into bulb 30. Bulb 30 has a vent opening 34 therein. Preferably, opening 34 on bulb 30 allows for air movement between the outside environment and enclosed volume 28. Vent 34 may optionally incorporate a valve system (not shown) to limit the direction and flow of air. In the most preferred embodiment, a balloon element 38 is disposed within container 12 and at least encloses valve 32 to be in fluid communication with enclosed volume 28. Balloon element 38 may be constructed from rubber or another elastomeric material. However, it should be noted that the present invention is functional without the employment of balloon element 38.

During operation of pump system 20, with reference to FIGS. 4A and 4B, pressure is manually applied to bulb 30 in direction 40. In doing so, vent opening 34 is closed. The pressure causes bulb 30 to depress into enclosed volume 28 toward internal member 26 to cause air to be pushed through one-way valve 32 in direction 42 and into balloon element 38. Balloon element 38 then expands with the increase in air pressure and pushes a composition 44 upward in direction 46 so that an amount of composition 44 is extruded through and thereby exits exit orifice 18. Once bulb 30 is fully depressed, as shown in FIG. 4C, one-way valve 32 closes so that the air cannot retreat from balloon element 38 into bulb 30. Bulb 30 re-inflates by the flow of air into opening 28 through vent opening 34.

In a second preferred embodiment, package 110, similarly to package 10, includes a container 112 with opposing first and second ends, 114 and 116, respectively, side wall 122, and a cap 124 seated on container 112. In the preferred embodiment, container 112 is constructed from thermoplastic materials. Polyolefins such as polyethylene and, preferably, polypropylene, are most suitable plastic materials. Other suitable material known to persons of ordinary skill in the art is contemplated to be within the scope of the present invention.

First end 114 has exit orifice 118. In other embodiments, first end 114 may contain a plurality of exit orifices 118, depending on the design desired for container 112. In the preferred embodiment, a pump system 120 is located on side wall 122 of container 112. It should be noted that pump system 120 may be located at any location on container 112 other than first end 114. The flexibility of pump system 120 allows for any shape container 112. Cap 124 is seatable over first end 114 to enclose exit orifice 118 when package 110 is not in use.

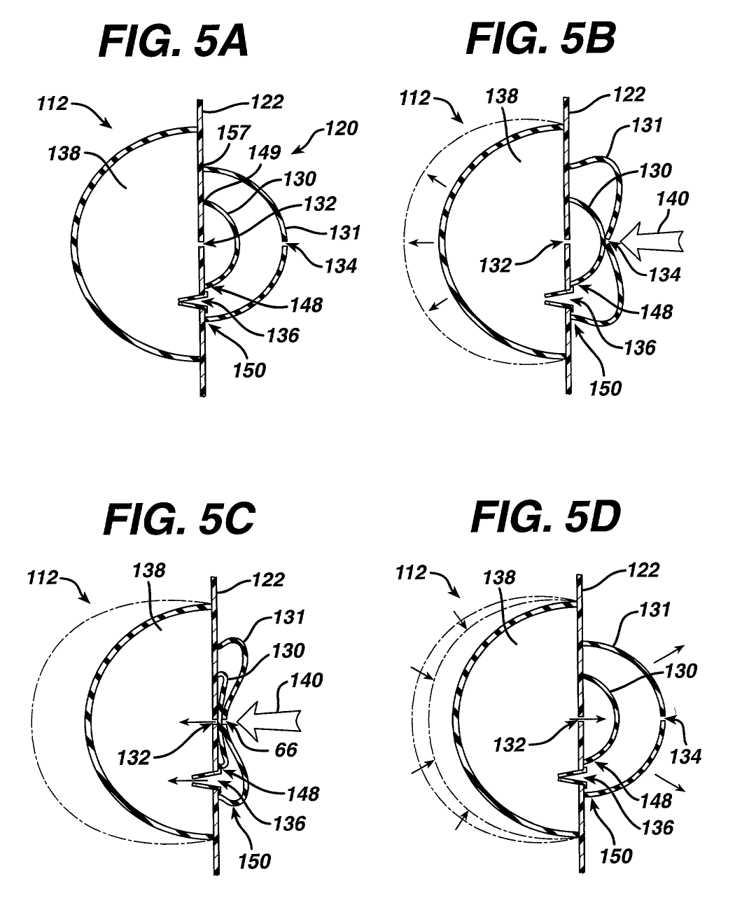

Further with reference to the second preferred embodiment, providing for pressure relief after inflation, FIGS. 5A-D are diagrams of pump system 120. Pump system 120 comprises a first bulb 130 extending over an opening 132 on side wall 122 of container 112 from its perimeter edge 148 defining a mouth thereof. A second bulb 131 extends beyond first bulb 130 from its perimeter edge 150 and is concentric with perimeter edge 148, so as to encompass bulb 130. When bulbs 130 and 131 are semi-spherical, as in the illustrative example of FIGS. 5A-5D, perimeter edges 148 and 150 are concentric circumferential edges. An exhaust valve 134 is located on second bulb 131, preferably, at a location on the same plane perpendicular to side wall 122 as opening 132. A valve 136 is located on side wall 122 between perimeter edge 148 of first bulb 130 and perimeter edge 150 of second bulb 131. Valve 136 is preferably a one-way valve, in the direction of container 112. A balloon element 138 extends within container 112 about valve 136 and opening 132 to be in fluid communication with the volumes of bulbs 130,131. In another aspect, as a variation, bulb 130 and bulb 131 can be disposed adjacently.

Bulb 131 may be integrally formed, such as by bi-injection molding, with side wall 122, where side wall 122, could be molded from a polyolefin thermoplastic and the area encompassing bulb 131 could be molded from an elastomeric or rubber material.

During operation, with reference to FIG. 5B, second bulb 131 is manually compressed in direction 140, shutting exhaust valve 134, so that air is transferred into container 112 through valve 136 to expand balloon element 138 and push composition 144 through container 112. As seen in FIG. 5C, first bulb 130 also compresses to push air into balloon element 138 through opening 132. During decompression, as seen in FIG. 5D, some air can return back from balloon element 138 into first bulb 130 through opening 132 releasing pressure from balloon element 138. This feature is designed to accommodate compositions 144 that are sensitive to pressure during operation of package 110. Second bulb 131 re-inflates through valve 134. The percentage of air that can return from balloon element 138 to first bulb 130 is about 5% to about 95%. Preferably, about 10% is released back into first bulb 130. Thereby, pressure relief on composition 144 is achieved. The degree of pressure relief varies with the percentage of air returning into first bulb 130 and can be controlled by adjusting the ratio of the volumes of first bulb 130 and second bulb 131. The ratio of the volumes of first and second bulbs 130 and 131 may be about 1:20 to about 1:5.

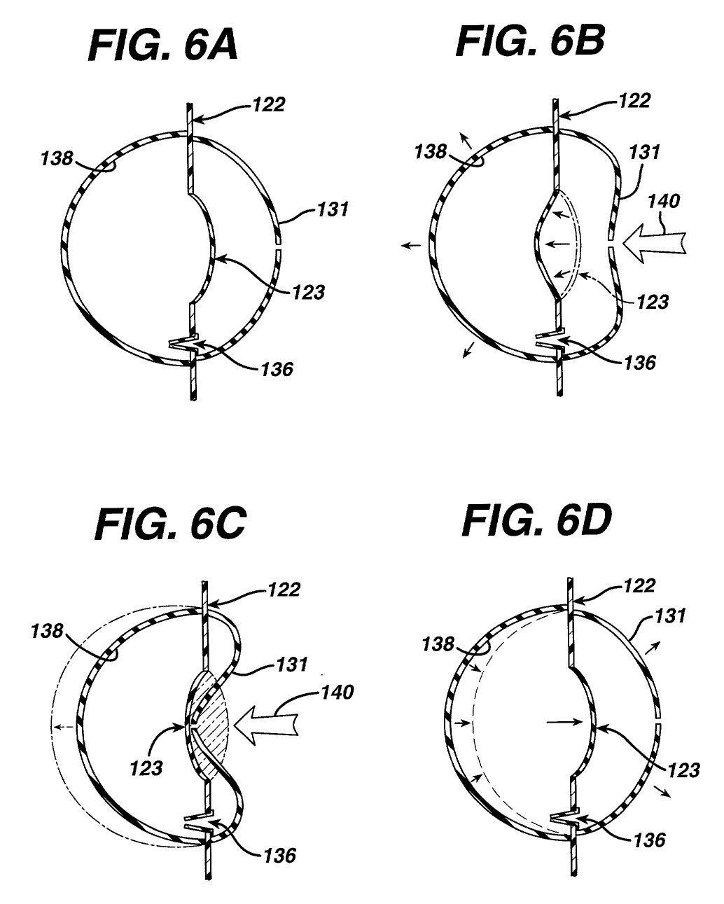

With reference to FIGS. 6A-D, as a variation, first bulb 130 can be omitted and the functionality of first bulb 130 can be achieved by controlling the flexibility of a defined section 123 of side wall 122. This can be achieved through variations in the material position and/or distribution, or bi-injection. Section 123 is an integral segment of side wall 122 and, preferably, projects outwardly from container 112 in its static state, as shown in FIG. 6A. The shape or geometry of section 123 may be varied or adjusted, allowing the control of flexibility thereof, thereby achieving functionality similar to that of first bulb 130 of the variant of FIGS. 5A-D. Section 123 could be molded in a preferential position in relation to second bulb 131, preferably inverted into the air volume captured within second bulb 131. By virtue of the physical characteristics imposed on the defined section 123 of side wall 122, section 123 will preferably wish to return to its molded position. In operation, as second bulb 131 is manually depressed, section 123 of side wall 122 will flex from its molded position in direction of 140 into balloon element 138. Once section 123 has flexed to its maximum extent, air from second bulb 131 will pass through valve 136 into balloon element 138. Upon decompression, a controlled degree of pressure relief will be achieved by the change in geometry of balloon element 138 as described by the change in the geometric position of wall section 123, moving from its maximum extension state back to its preferential molded position. The degree of pressure relief can be varied by adjusting the geometry of wall section 123.

The present invention package is particularly suitable for flowable cosmetic compositions, particularly antiperspirant and deodorant compositions, preferably in cream form. Examples of suitable antiperspirant and deodorant compositions are as follows.

An antiperspirant composition includes an antiperspirant active. The proportion of antiperspirant active present in the composition according to the invention may be about 1% to about 35% by weight of the composition, preferably at least about 5% by weight and more preferably about 15% to about 30% by weight of the base composition. A base composition herein excludes any propellant that may be employed.

Examples of suitable actives include aluminium salts, zirconium salts, aluminium and/or zirconium complexes, for example aluminium halides, aluminium hydroxy halides, zirconyl oxyhalides, zirconyl hydroxyhalides, and mixtures thereof. Specific examples include activated aluminium chlorohydrate, aluminium chlorohydrate, aluminium pentachlorohydrate and aluminium zirconium chlorohydrate. Useful zirconium salts include zirconium hydroxy-chloride and zirconium oxychloride. Other generally used actives will be known to those skilled in the art. Preferred actives include ZAG (Zirconium Aluminium Glycine), AAZG (Activated Aluminium Zirconium Glycine), and AACH (Activated Aluminium Chlorohydrate). The antiperspirant active can be present in particulate form whereupon it is normally suspended in a suitable carrier fluid, which usually is water-immiscible, and which can be structured or thickened. Alternatively the active can be dissolved in a polar solution, such as for example in aqueous solution or in a polar low weight polyhydric alcohol such as propylene glycol, advantageously about 30% to about 60% by weight solution.

The deodorant compositions normally comprise about 0.01 to about 90% of a deodorant active. The deodorant active used in the cosmetics of the invention can be any deodorant active known in the art such as alcohols, in particular aliphatic monohydric alcohols such as ethanol or propanol, antimicrobial actives such as polyhexamethylene biguanides, e.g., those available under the trade name Cosmocil™ or chlorinated aromatics, e.g., triclosan available under the trade name Irgasan™, non-microbiocidal deodorant actives such as triethylcitrate, bactericides and bacteriostats. Yet other deodorant actives can include zinc salts such as zinc ricinoleate.

The carrier material for the compositions according to the invention can comprise one or more of volatile carrier fluids, one or more of non-volatile emollients, and it can be structured or thickened by one or a combination of thickener and/or structurant materials if required. The carrier material, including, where relevant, carrier materials providing additional properties such as emolliency, can often comprise up to about 99 wt %, in many instances about 5 to 90 wt % and particularly about 10 to about 70 wt % of the composition, or of the base composition, if mixed subsequently with a propellant. Where the composition comprises both hydrophilic and hydrophobic phases, the weight ratio of the two phases is often in the range of about 10:1 to about 1:10.

The antiperspirant or deodorant composition can consist of a mixture of particulate solids or a suspension of solids in a liquid medium, which can be thickened to reduce the rate of segregation or structured to produce a cream (soft solid) or even solid. Alternatively, the composition can be a mixture of liquid constituents, including a solution of an active in a carrier, such a composition often adopting the form of an oil-in-water or water-in-oil emulsion, which may be thickened or gelled.

The carrier material, which may be a fluid or a mixture of fluids, is often selected according to the physical form of the cosmetic composition, e.g. volatile low viscosity silicones, low molecular weight hydrocarbons, alcohols and water, and can be selected by those skilled in the art to provide appropriate physical and sensory properties for the product. It will be understood that certain fluid alcohols such as in particular ethanol can constitute both a carrier and a deodorant active simultaneously, though advantageously formulations containing such a material also contain an additional deodorant and/or antiperspirant active.

The thickening or structurant agent, when required, is selected according to the product form of the cosmetic composition. The thickening or structuring agent can be organic (monomeric or polymeric) or inorganic and is usually chosen depending on the physical nature of the liquid phase to be thickened or structured, such as whether it is hydrophobic or hydrophilic. The amount is normally selected in order to attain the desired viscosity of the liquid or cream or desired resistance to penetration of a solid in accordance with the present invention.

Soft solid or cream formulations herein usually have a hardness of at least about 0.00003 N/mm², preferably at least about 0.003 N/mm² at 25° C. Hardness, especially of soft solids, can be measured by a conventional sphere indentation technique, using a Stable Micro systems TA.XT2I™ Texture Analyser. In some formulations in the form of soft solids herein, the so measured hardness is up to about 0.05 N/mm² at 25° C. and particularly up to about 0.02 N/mm² at 25° C. In other and harder formulations in stick form, their hardness is greater than about 0.05 N/mm² at 25° C. and particularly greater than about 0.1 N/mm² at 25° C.

The thickener or structurant can be any of a number of materials, including, for example, waxy structurants for a formulation containing a water-immiscible phase including hydrogenated vegetable oil, hydrogenated castor oil, fatty acids, such as 12-hydroxystearic acid (12-HSA), or ester or amide derivatives of such acids, beeswax, paraffin wax, microcrystalline waxes, silicone wax, and fatty alcohols, such as stearyl alcohol. The structurant can also be a fibre-forming gellant, of which 12-HSA is an example. Other examples include N-acyl amino acid amides and esters, including particularly GP-1 (N-Lauroyl-L-glutamic acid di-n-butylamide), lanosterol, combinations of a sterol and a sterol ester, such as especially β-sitosterol and χ-oryzanol, a polyesterified cellobiose, especially with a C8 to C10 aliphatic acid, threitol esters of and selected secondary amides of di or tri basic carboxylic acids, (e.g., 2-dodecyl-N,N′-dibutylsuccinimide) by themselves or in combination.

Polymeric materials for thickening include polymers such as polyamides, hydroxypropylcellulose, and natural or synthetic gums, such as polyglycerides including agar, agarose, pectin, or guars or mixtures or combinations thereof. One class of materials worthy of attention for thickening a water-immiscible phase includes derivatives of hydrolyzed starch or other polysaccharides, including in particular esterified dextrins, such as dextrin palmitate. A further class of polymers that is particularly directed to structuring an oil phase containing a silicone oil comprises polysiloxane elastomers. Suspending agents such as silicas or clays such as bentonite, montmorillonite or hectorite, including those available under the trademark Bentone can also be employed to thicken liquid compositions according to the invention. The composition can be thickened with non-polymeric organic gellants, including selected dibenzylidene alditols (e.g., dibenzylidene sorbitol).

The amount of structurant or thickening agent that can be employed in the invention compositions will depend upon the viscosity of a fluid formulation or extent of hardness of a solid formulation that the producer wishes to attain. The amount to be employed will, in practice, also vary depending on the chemical nature of the structurant or thickening agent. In many instances, the amount of structurant or thickening agent will be selected in the range of about 0.1 to about 25 wt %, and particularly about 1 to about 15 wt %.

Other ingredients contemplated within the personal deodorant or antiperspirants art can also be included in the compositions according to the invention, depending on the nature and form of the finished product. These include, for example, surfactants/wash-off agents, fillers, fragrances, antioxidants, preservatives and colouring agents. Such ingredients and their amounts of use are usually selected according to the physical and chemical form of the cosmetic composition. Other optional ingredients are other cosmetic adjuncts conventionally employed or contemplated for employment in antiperspirant or deodorant products.

Various other embodiments of the present invention are contemplated to be within the scope of the present invention.

What is claimed is:

1. A package for dispensing a composition for topical application to human skin comprising:
a) a container housing a cosmetic composition having a hardness of at least about 0.003 N/mm² at 25° C.;
said container having opposing first and second ends;
said first end having at least one exit orifice; and
b) a pump system for extruding said composition through said at least one exit orifice, said pump system comprising:
(b1) a bulb affixed to said container and extending therefrom at a location other than said first end; said bulb having an opening therein;
(b2) an internal member secured to said container and extending into said container;
(b3) said bulb and said internal member being affixed to define an enclosed volume therein;
(b4) a valve located within said internal member and extending into said container.

2. The package of claim 1 wherein said valve is a one-way valve.

3. The package of claim 1 wherein said bulb is affixed to said internal member and said container by a heat seal mechanism, a clip seal mechanism, or by ultrasonic welding.

4. The package of claim 1 wherein said pump system further comprises a balloon element disposed within said container adjacent said internal member; and wherein said valve extends from said internal member into said balloon element; whereby compression of said bulb transmits air through said valve into said balloon element to inflate said balloon element.

5. The package of claim 1 wherein the composition is a deodorant composition, an antiperspirant composition, or combinations thereof.

6. The package of claim 1 wherein said bulb is molded from an elastic material with good memory.

7. The package of claim 1 further comprising a cap seatable over said first end of said container.

8. The package of claim 1 further comprising a support member extending from said container and housing said bulb.

9. The package of claim 1 wherein said internal member is comprised of a rigid material or an elastic material.

10. A package for dispensing a composition for topical application to human skin comprising:
a) a container housing a cosmetic composition having a hardness of at least about 0.003 N/m² at 25° C.;
said container having opposing first and second ends;
said first end having at least one exit orifice;
said container having an opening in a position other than said first end;
b) a pump system for extruding said composition through said exit orifice; said pump system located on said container in said position other than said first end; said pump system comprising:
(b1) a bulb system secured to said container and projecting outwardly therefrom at said position other than said first end over said opening therein; said bulb system comprising a first bulb having a perimeter edge and extending over said opening and a second bulb having a perimeter edge and projecting outwardly from said container beyond and encompassing said first bulb; wherein said respective perimeter edges of said first bulb and said second bulb are concentrically adjacent; wherein said second bulb has an opening therein;
(b2) a valve located at said position other than said first end; and
(b3) a balloon element disposed within said container; said balloon extending at least so as to enclose said valve and said opening in said container; whereby compression of said bulb system transmits air through said valve and into said balloon to inflate said balloon.

11. The package of claim 10 wherein said composition is a deodorant composition, an antiperspirant composition, or combinations thereof.

12. The package of claim 10 further comprising a cap seatable over said first end of said container.

13. The package of claim 10 wherein a valve is located on said container and between said first or second edge of said first bulb and an adjacent first or second edge of said second bulb.

14. The package of claim 10 wherein compression of said second bulb compresses said first bulb.

15. The package of claim 10 wherein said pump system provides pressure relief on said composition, wherein said pressure relief can be controlled by adjusting the ratio of volumes of said first bulb and said second bulb.

16. The package of claim 10 wherein said first bulb extends about said opening in said container; said second bulb extends about said valve; and wherein said first and second bulbs are adjacent.

17. The package of claim 10 further comprising a support member extending from said container and housing said bulb system.

18. The package of claim 10 wherein said valve is a one-way valve.

19. A package for dispensing a composition for topical application to human skin comprising:
a) a container housing a cosmetic composition having a hardness of at least about 0.003 N/M² at 25° C.;
said container having opposing first and second ends and a side wall; said side wall having a section extending outwardly therefrom at a position other than said first end;
said first end having at least one exit orifice;
b) a pump system for extruding said composition through said exit orifice; said pump system located on said container in said position other than said first end; said pump system comprising:
(b1) a bulb system secured to said container and projecting outwardly therefrom at said position other than said first end; said bulb system comprising said section having a perimeter edge and a bulb having a perimeter edge and projecting outwardly from said container beyond and encompassing said section; wherein said respective perimeter edges of said section and said bulb are concentrically adjacent; wherein said bulb has an opening therein;
(b2) a valve located at said position other than said first end; and
(b3) a balloon element disposed within said container; said balloon extending at least so as to enclose said valve and said section in said container; whereby compression of said bulb system transmits air through said valve and into said balloon to inflate said balloon.
